(19) United States
(12) Patent Application Publication
(10) Pub. No.: US 2013/0325683 A1
(43) Pub. Date: Dec. 5, 2013

(54) Dynamic Trading Services For Passive Investors

(71) Applicant: Hamid Benbrahim, Boston, MA (US)

(72) Inventor: Hamid Benbrahim, Boston, MA (US)

(73) Assignee: FMR LLC

(21) Appl. No.: 13/482,080

(22) Filed: May 29, 2012

(51) Int. Cl. G06Q 40/04

(52) U.S. Cl. 705/37

(57) ABSTRACT

A dynamic trading investment product and techniques for administering such a product are described. The dynamic trading investment product holds at least one security and includes establishing a dynamic trading investment product account for an investor, receiving from an investor a budget parameter established by the investor for the security, monitoring by one or more computers the price of the security during secondary trading on a trading venue, determining by one or more computers according to the monitored price and target growths whether to issue orders to buy or sell the security; and when determined to issue orders, issuing orders to buy or orders to sell the according to the monitored price and target growths, and adding shares to or removing shares from the dynamic trading investment product of the investor according to whether the issued orders are orders to buy or sell the security.

### BACKGROUND

This invention relates to trading of securities.

Individual investors can currently buy mutual funds, individual securities, hire a professional money manager, or use advanced software tools like Wealth Lab Pro to implement trading strategies. Many investors however desire to be passive investors.

Such investors want to personally buy individual securities, but do not want to be actively involved in monitoring their securities on a very frequent basis, e.g., hourly or daily, and instead implement buy and hold strategies typical of investors that buy for the long term. In addition, some individual investors do not have the expertise to use trading tools, and thus typically buy and hold the securities until they decide to ultimately liquidate their positions. An investor that buys and holds, does not benefit from intermediary price movements of the security that occur between the buy and an ultimate selling of the security, e.g., during the vast hold period.

### SUMMARY

According to an aspect of the invention, a method of administering a dynamic trading investment product that holds at least one security includes establishing a dynamic trading investment product account for an investor, receiving from an investor a budget parameter established by the investor for the security, monitoring by one or more computers the price of the security during secondary trading on a trading venue, determining by one or more computers according to the monitored price and target growths whether to issue orders to buy or sell the security; and when determined to issue orders, issuing orders to buy or orders to sell the according to the monitored price and target growths, and adding shares to or removing shares from the dynamic trading investment product of the investor according to whether the issued orders are orders to buy or sell the security.

According to an additional aspect of the invention, a computer program product tangible stored on a computer readable storage device for administering a dynamic trading investment product that holds at least one security, the computer program product includes instructions for causing a processor to establish a dynamic trading investment product account for an investor, receive from an investor a budget parameter established by the investor for the security, monitor the price of the security during secondary trading on a trading venue, determine according to the monitored price and target growths whether to issue orders to buy or sell the security; and when determined to issue orders, cause an issue of orders to buy or orders to sell the according to the monitored price and target growths, and add shares to or removing shares from the dynamic trading investment product of the investor according to whether the issued orders are orders to buy or sell the security.

According to an additional aspect of the invention, a system includes a processor and memory coupled to the processor with the processor configured to execute a computer program product for administering a dynamic trading investment product that holds at least one security, the computer program product comprising instructions for causing the processor to establish a dynamic trading investment product account for an investor, receive from an investor a budget parameter established by the investor for the security, monitor the price of the security during secondary trading on a trading venue, determine according to the monitored price and target growths whether to issue orders to buy or sell the security; and when determined to issue orders, cause an issue of orders to buy or orders to sell the according to the monitored price and target growths, and add shares to or removing shares from the dynamic trading investment product of the investor according to whether the issued orders are orders to buy or sell the security.

The following embodiments are within the scope of aspects.

To establish the dynamic trading investment product, the dynamic trading investment product has a security, a target price and a target growth. A trading band is determined that is a value of the target price of the security and a target growth amount plus an amount that accounts for trading fees involved in a transaction involving a buy or sell order. Buy orders are issued when the total amount invested in the security does not exceed the allocated budget and customer has available funds and the monitored price is below the trading band value. Sell orders are issued when the monitored price is above a trading band value. The target growth is a first set and the budget is a first budget a firm that markets the dynamic trading investment product, establishes plural dynamic trading investment products for a security, with each of the dynamic trading investment products having an established target growth and target price. The firm would receive a selection of one or more of the sets of target growths and corresponding budget amounts for each of the one or more selected sets of target growths. Cash generated by the security though dividends is deposited in a cash account. The dynamic trading fund holds plural different securities, each security having its own set of target prices and target growths. The investors select the security, target price and target growth.

One or more of the following advantages may be provided from one on more of the above aspects of the invention.

Investing using a dynamic trading investment product provides advantages that are not typically obtained by a long term passive investor. The dynamic trading investment product achieves the same goals as a buy and hold strategy, except that dynamic trading investment product allows individual investors to benefit from price movements away from a specified target price of the security, without that investor becoming actively involved in a trading strategy. The investor does not specify when to buy or sell a security. Rather, the investor specifies a target growth that is used to determine a trading band outside of which the service will conduct trades on the individual investor's behalf depending on where outside the trading band the price is. This trading strategy that is couple with a security in the dynamic trading investment product permits individual investors to benefit from intermediate pricing movements in the security and still maintain what is essentially a buy and hold strategy without the need for detailed involvement by the individual investor.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a block diagram of a system.

FIGS. 2A-2C are a series of flow charts.

FIG. 3 is block diagram depicting diagrammatically storage of account relationships for customer trading options.

FIG. 4 is block diagram depicting exemplary storage of customer trading options.

FIG. 5 is a block diagram depicting exemplary established growth targets.

FIG. 6 is a flow chart depicting a dynamic trading algorithm.

### DETAILED DESCRIPTION

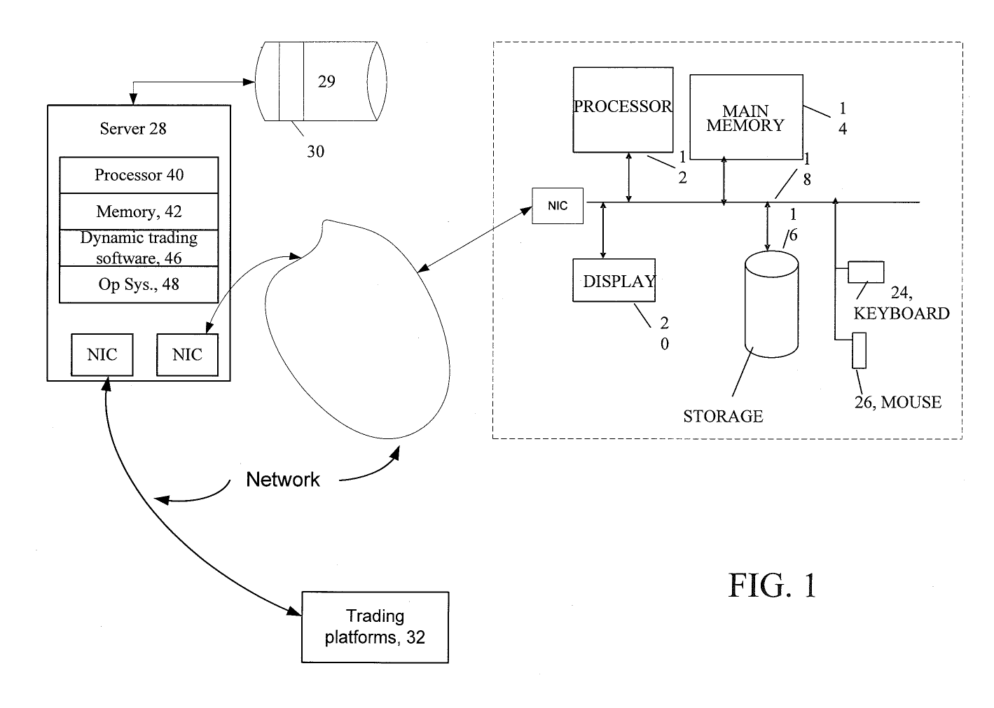

Referring now to FIG. 1, a system 10 for implementing a dynamic trading investment product that is a vehicle that holds at least one security and a settable trading strategy which are marketed together is shown. The system 10 includes a client computer 11, including a CPU, e.g., a processor 12, main memory 14 and persistent storage device 16, all coupled via a computer bus 18. The client 11 also includes output devices such as a display 20 as well as user-input devices such as a keyboard 24 and a mouse 26. Not shown, but necessarily included are software drivers and hardware interfaces to couple all the aforementioned elements to the processor 12. The client 11 also includes an operating system executed by the processor in memory and includes a web browser that communicates with a web server (not shown), which in turn communicates with server 28.

The server 28 is coupled to the client 11, e.g., over a network, e.g., the Internet in a conventional client-server arrangement. The server 28 may be any type of computing device or multiple computing devices. Server 28 includes one or more processor(s) 40 (referred to simply as “processor 40”), NIC's (network interfaces), and memory 42 that stores software 44 to be executed by the processor 40. The server 28 also includes storage 29 that holds a database 30. Storage 29 can be local to the server or remote accessible over a network. Communication NIC's facilitates communication between the server 28 and clients 11 coupled typically via the Internet, and a private network(s) coupled to trading platforms 32. Software 44 includes dynamic trading software 46 and operating system 48 software that can be stored/downloaded from a storage device (not shown) and that is executed by the server 28. Other databases that supply data to the server 28 can be dedicated or networked-based databases and in addition the server will receive either directly from a network or via other systems feeds with current pricing information for securities, typically from an exchange or market or other financial data supplier.

The dynamic trading investment vehicle is a financial product that is marketed by a financial services firm, such as an investment company, broker/dealer and so forth, herein after “firm.” The dynamic trading investment vehicle includes a registered security that trades on secondary markets coupled with a definable, set computer implemented trading strategy, and which is offered as a package to individual investors for a fee for implementing the trading strategy. The fee can be a one-time fee or a periodic fee or an annual fee or can be a fee that is assessed when a trade occurs.

In general, all issued securities that trade on secondary markets are registered securities. For example, in the United States shares of stock in publicly traded companies are registered with the SEC (Securities and Exchange Commission) by filing of a registration statement, at issuance. While it is not contemplated that dynamic trading investment product would require any separate registration apart from the registration that accompanies the securities that can comprise the dynamic trading investment products, it would still be within the scope of this disclosure were registration required at some juncture for dynamic trading investment products.

The dynamic trading investment product is a vehicle that permits a passive investor to obtain benefits of price movements away from a specified target price. In contrast with a buy and hold strategy typical of passive investors, where such passive investors do not obtain any benefits from intermediate price movements of the security, by investing in a dynamic trading fund product, the product achieves the same goal as a buy and hold strategy, to avoid excessive investor participation, yet allows the investor to reap benefits of price movements away from the specified target price. The investor does not specify when to buy or sell. The investor only specifies what they believe the price of a security should be, e.g., by specifying a target price.

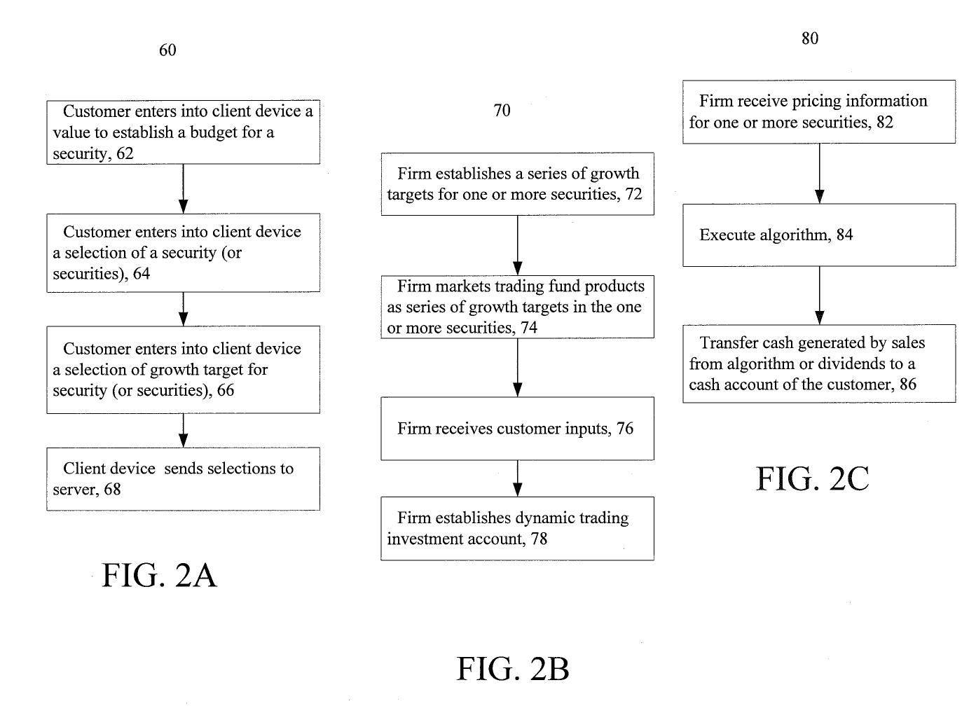

Referring now to FIG. 2A, one technique 60 for establishing a position in a dynamic trading investment product is shown. A firm markets dynamic trading investment products, allowing a customer to provide inputs to govern positions in one or more securities. More specifically, in this technique, a customer enters 62 with the client device 11 via a graphical user interface supplied by the server 28, e.g., through the web-browser (not shown) a budge value. The customer also enters 64 via the client device a selection of a security (or securities), each security having its own budget. The customer also enters 66 with client device, a selection of a growth target for each security (or securities). The client device 11 sends 48 these selections to the server 68.

Referring now to FIG. 2B, another technique 70 for establishing a position in a dynamic trading investment product is shown. In this technique, a firm establishes 72 a series of target prices with corresponding target growths that can be used to establish target growths for one or more securities. The firm actively markets various dynamic trading investment products for various securities. For example for a security “X” a firm can establish several target prices, and several target growths. For security X the target prices can be for instance $40, $50 and $60. The target growths can also be a series such as series +/−1%; +/−1.5%; +/−2%. Tighter series or series with smaller growth targets could be used. Alternatively, broader series or series with larger growth targets could be used. For example other series could be +/−0.5%; +/−1.0%; +/−1.5% or +/−3%; +/−4%; +/−5%.

In general, either for FIG. 2A or FIG. 2B, the values selected for the target growths are related to the volatility of the security “X” and especially trading costs associated with trading the security. The lower the trading costs the tighter and smaller the target growths could be and the more the volatility the wider and higher the targets could be. The firm can offer different target growths for example to allow for different fees for the service, with the higher target growths having lower fees.

Thus, in this example the firm could establish the following series of products for security “X” as depicted in Table I below.

| Target | +/−1% | +/−1.5% | +/−2%. |
|---|---|---|---|
| $40 | X $40 +/− 1% | X $40 +/− 1.5% | X $40, +/−2% |
| $50 | X $50 +/− 1% | X $50 +/− 1.5% | X $50, +/−2% |
| $60 | X $60 +/− 1% | X $40 +/− 1.5% | X $60, +/−2% |

The firm actively markets 74 these pre-specified trading products and thereafter receives a client selection of one or more of the products. In this situation, the firm would receive 76 from the client one of the above series, e.g., the series “X $40+/−1%” and a budget value in dollars. The customer enters these selections via the client device 11.

In either technique, the server 28 establishes 78 a dynamic trading investment product, for the customer by receiving the target growths set either as established by the firm or through customer input, the budget amount and security. The target growth set specifies a pair of thresholds to specify when trading actions occur in a security, as will be discussed below. The server 28 stores the budget parameter established by the investor for the security and produces portfolio and cash accounts.

Referring now to FIG. 2C, the service 80 executed by the server 28 proceeds as follows. After establishing the dynamic trading investment product account for the customer and a corresponding cash account, (FIG. 2B, 78) the firm continuously 82 receives pricing information for the security “X” and the firm computers monitor the price of the security during trading on an exchange or market. The pricing information is obtained by the firm in conventional manner. The firm periodically executes 84 the dynamic trading algorithm (as discussed below) and makes transfers 86 of cash generated by sales from algorithm or dividends to the cash account of the customer. The firm computers will issue orders to buy or orders to sell the security according to the monitored price and target growths, and other information, adding shares to or removing shares from the dynamic trading account of the investor according to whether the issued orders are orders to buy or sell the security, as will be further discussed below.

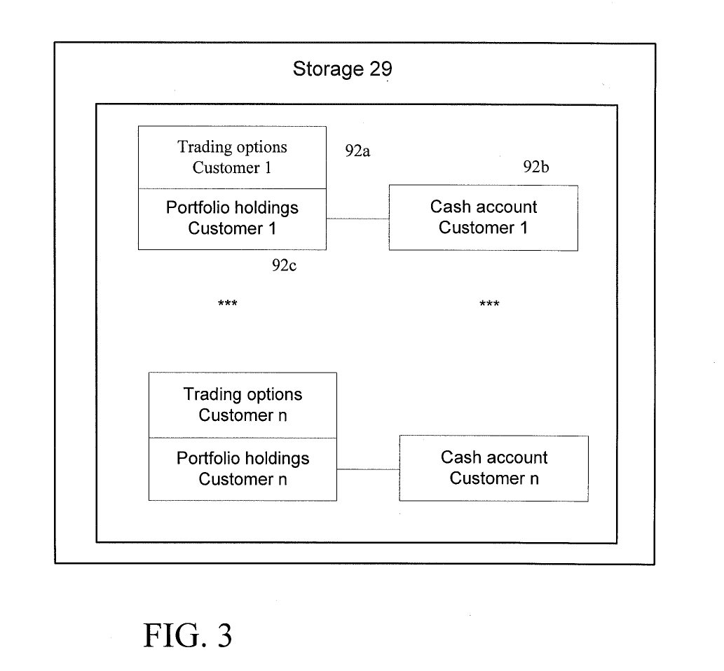

Referring now to FIG. 3, an exemplary depiction of trading account accessed by the server 28 and stored on storage 29 is shown. In this example, there are a portfolio account 92a and a cash account 92b per customer and a profile 92c of trading options per customer, as shown for Customer 1. As shown in FIG. 3, many such customers can be managed by the server 28, with each having a portfolio account and a cash account per customer and a profile of trading options. In some implementations, each portfolio account holds but one security, and is linked to one cash account, whereas in other implementations a portfolio account can hold plural securities for the customer and linked to one cash account.

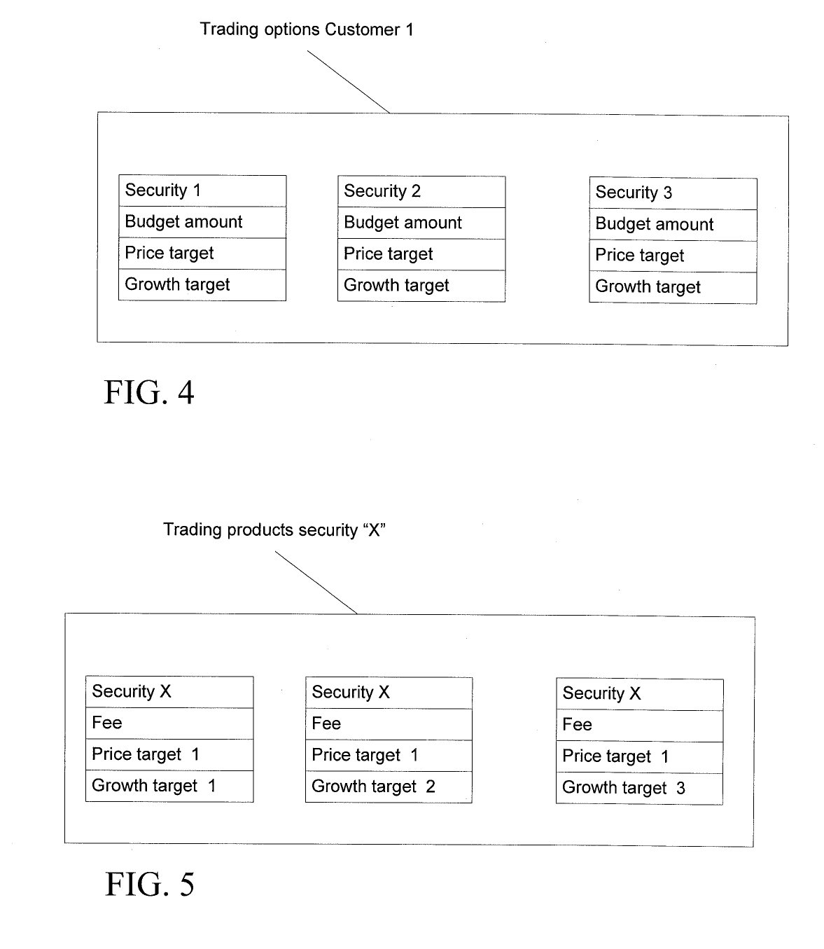

Referring now to FIG. 4, an exemplary depiction of trading options is shown. In this depiction there is one set of options for each security for a particular customer, e.g., Customer 1. Here there is shown trading options for three securities, security 1, security 2 and security 3. Each of security 1, security 2 and security 3 has provisions (fields) for a budget amount, a price target and a growth target. Values for these fields are populated from one of the described techniques for establishing positions, as discussed above in conjunction with FIGS. 2A and 2B. Others could be used.

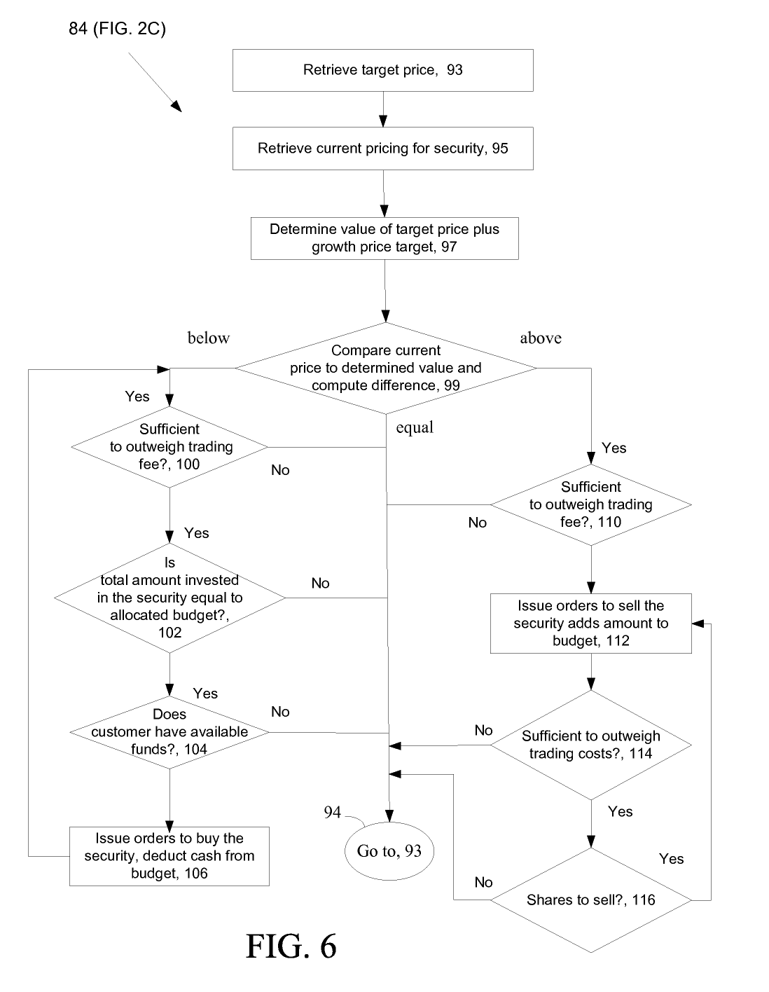

Referring now to FIG. 5, an exemplary depiction of three different trading products established by the firm is shown. In this depiction there is one set of growth target options for each product for security “X.” For example, for security X there are three (as described above in Table 1) each different growth targets, a price target and fee that is payable to the firm that provides the dynamic trading investment product for security “X.” Each of the fields are populated from the described technique as discussed above in conjunction with FIG. 2B. The fee is set by the firm and is based on several factors including the growth target, the amount of trading anticipated which would take into consideration volatility, the volume that is normally traded in the security, and so forth.

Referring now to FIG. 6, the trading algorithm 84 executed by the server 28 is shown. The server 28 retrieves 93 target price information for the security, and retrieves 95 current pricing for security. The server 28 determines 97 a value that is the target price plus the growth target. The sever compares 99 the current price of the security to the determined value (target price plus the growth target) and computes a difference between the current price and the determined value.

If the server 28 determines that current price is below the determined value of the security, the server 28 determines if the computed difference value is sufficiently high 100 to outweigh trading costs, e.g., commission fees, etc., and the server also determines if the total amount invested in security “X” in the customer's account is less than the budget 102 and the server also determines whether the customer has available funds 104 in the cash account. When each of these conditions are met, the server issues 106 orders to buy the security and continues to do until either the budget is reach, the cash is exhausted or the determined value no longer outweighs the trading fee. The sever 28, as trades are made, deducts cash from a remaining budget amount (original budget amount minus value of securities in account) and also deducts cash from the cash account to account for the cash used to buy securities “X.” Thus, “buy orders” are issued when the total amount invested in the security does not exceed the allocated budget and customer has available funds and the monitored price is below the trading band value.

Conversely, if the server 28 determines that current price is above the determined value of the security, the server 28 determines if the computed difference value is sufficiently high 110 to outweigh trading costs, e.g., commission fees, etc., the server issues 112 orders to sell the security and transfers resulting funds into the cash account. The server 28 continues to sell until the determined value no longer outweighs the trading costs 114 or until there are no longer any shares to sell. The sever 28, as trades are made, adds the resulting cash to the cash account to account for the cash received from selling the securities in “X.”

This process of buying and selling can be repeated indefinitely with the budget value of securities restored periodically so that the server 28 can keep the investor generally invested at the selected budget. However, additional cash generated from the trading can remain in the cash account or can be transferred to another account set up for the investor. This additional cash (minus transaction fees and trading product fees) represents additional capital gains for the investor that is provided from intermediate price movements.

In some embodiments, the trading band is a percentage value of the current price of the security that is equal to or greater than a target growth amount plus an amount that accounts for trading fees involved in a transaction involving a buy or sell order. Sell orders are issued when the monitored price is above the trading band value.

This dynamic trading investment product is applicable to any security each security having its own set of target growths that are either specified by a firm or by an individual, as described above. In the example where investors specify the target price and target growth, the investors can change either of these settings at any time. The investors can also change the budget and/or securities at any time for either way of establishing a position.

Customer devices can be any sort of computing device capable of taking input from a customer and communicating over a network (not shown) with server and/or with other client devices. For example, customer device can be a mobile device, a desktop computer, a laptop, a cell phone, a private digital assistant (“PDA”), a server, an embedded computing system, a mobile device, as well as the eyeglasses, and so forth. Customer devices include a monitor device that renders the visual representations.

Server can be any of a variety of computing devices capable of receiving information, such as a server, a distributed computing system, a desktop computer, a laptop, a cell phone, a rack-mounted server, and so forth. Server may be a single server or a group of servers that are at a same location or at different locations.

Server can receive information from client devices via interfaces. Interfaces can be any type of interface capable of receiving information over a network, such as an Ethernet interface, a wireless networking interface, a fiber-optic networking interface, a modem, and so forth. Server also includes a processor and memory. A bus system (not shown), including, for example, an information bus and a motherboard, can be used to establish and to control information communication between the components of server.

Processor may include one or more microprocessors. Generally, processor may include any appropriate processor and/or logic that is capable of receiving and storing information, and of communicating over a network (not shown). Memory can include a hard drive and a random access memory storage device, such as a dynamic random access memory, machine-readable media, or other types of non-transitory machine-readable storage devices.

Components also include storage device, which is configured to store information such as the instruction code to implement the processes disclosed herein.

Embodiments can be implemented in digital electronic circuitry, or in computer hardware, firmware, software, or in combinations thereof. Apparatus of the invention can be implemented in a computer program product tangibly embodied or stored in a machine-readable storage device and/or machine readable media for execution by a programmable processor; and method actions can be performed by a programmable processor executing a program of instructions to perform functions and operations of the invention by operating on input information and generating output. The invention can be implemented advantageously in one or more computer programs that are executable on a programmable system including at least one programmable processor coupled to receive information and instructions from, and to transmit information and instructions to, an information storage system, at least one input device, and at least one output device. Each computer program can be implemented in a high-level procedural or object oriented programming language, or in assembly or machine language if desired; and in any case, the language can be a compiled or interpreted language.

Suitable processors include, by way of example, both general and special purpose microprocessors. Generally, a processor will receive instructions and information from a read-only memory and/or a random access memory. Generally, a computer will include one or more mass storage devices for storing information files; such devices include magnetic disks, such as internal hard disks and removable disks; magneto-optical disks; and optical disks. Storage devices suitable for tangibly embodying computer program instructions and information include all forms of non-volatile memory, including by way of example semiconductor memory devices, such as EPROM, EEPROM, and flash memory devices; magnetic disks such as internal hard disks and removable disks; magneto-optical disks; and CD_ROM disks. Any of the foregoing can be supplemented by, or incorporated in, ASICs (application-specific integrated circuits).

A number of embodiments of the invention have been described. Nevertheless, it will be understood that various modifications may be made without departing from the spirit and scope of the invention. For example, while tax consequences were not discussed, the trading algorithm can also take into consideration tax consequences of trade timing. For example, under current tax laws capital gains on positions held over a year are considered long term and are subject to more favorable tax treatment. The trading algorithm could be modified to factor in consideration of tax consequences, for example by access when the positions were originally made and whether trades could prevent pending long term gain treatment of the position. Further, still the trading algorithm could also factor in tax treatments when making trading decisions. These additional factors and how to deal with them can be subject to investor selection and/or confirmation. Accordingly, other embodiments are within the scope of the following claims.

1. A method of administering a dynamic trading investment product that holds at least one security, the method comprising:
establishing a dynamic trading investment product account for an investor, the dynamic trading investment product account holding at least one security;
receiving from an investor a budget parameter established by the investor for the security, the budget parameter being a value of an amount of the at least one security;
monitoring by one or more computers the price of the at least one security during secondary trading on a trading venue;
determining by one or more computers according to the monitored price, and target growths whether to issue orders to buy or sell the security; and when determined to issue orders,
issuing orders to buy or orders to sell the according to the monitored price and target growths; and
adding shares to or removing shares from the dynamic trading investment product of the investor according to whether the issued orders are orders to buy or sell the security.

2. The method of claim 1 further comprising:
establishing by the one or more computers the dynamic trading investment product, the dynamic trading investment product having the at least one security, a target price value for the at least one security and target growths for the at least one security, with the target growths providing a pair of thresholds to specify when trading actions occur in the at least one security.

3. The method of claim 2 further comprising determining a trading band that is a value of the target price of the at least one security and the target growth amount plus an amount that accounts for trading fees involved in a transaction involving a buy or sell order.

4. The method of claim 2 wherein buy orders are issued when the total amount invested in the security does not exceed the budget parameter and the customer has available funds and the monitored price is below the trading band value.

5. The method of claim 1 wherein sell orders are issued when the monitored price is above a trading band value.

6. The method of claim 2 wherein sell orders are issued when the monitored price is above the trading band value.

7. The method of claim 1 wherein the target growth is a first set and the budget is a first budget further comprising:
establishing by a firm that markets the dynamic trading investment product, plural dynamic trading investment products for a security, with each of the dynamic trading investment products having an established target growth and target price.

8. The method of claim 7 further comprising:
receiving by the one or more computers a selection of one or more of the sets of target growths and corresponding budget amounts for each of the one or more selected sets of target growths.

9. The method of claim 1 further comprising:
depositing cash generated by the security though dividends in a cash account.

10. The method of claim 1 wherein the dynamic trading fund holds plural different securities, each security having its own set of target prices and target growths.

11. The method of claim 10 wherein the investors select the security, target price and target growth.

12. A computer program product tangible stored on a computer readable storage device for administering a dynamic trading investment product that holds at least one security, the computer program product comprising instructions for causing a processor to:
establish a dynamic trading investment product account for an investor, the dynamic trading investment product account holding at least one security;
receive from an investor a budget parameter established by the investor for the security, the budget parameter being a value of an amount of the at least one security;
monitor the price of the at least one security during secondary trading on a trading venue;
determine according to the monitored price and target growths whether to issue orders to buy or sell the security; and when determined to issue orders,
cause an issue of orders to buy or orders to sell the according to the monitored price and target growths; and
add shares to or removing shares from the dynamic trading investment product of the investor according to whether the issued orders are orders to buy or sell the security.

13. The computer program product of claim 12 further comprising instructions to:
establish the dynamic trading investment product, the dynamic trading investment product, the dynamic trading investment product having the at least one security, a target price value for the at least one security and target growths for the at least one security, with the target growths providing a pair of thresholds to specify when trading actions occur in the at least one security.

14. The computer program product of claim 12 further comprising instructions to:
determine a trading band that is a value of the target price of the security and the target growth amount plus an amount that accounts for trading fees involved in a transaction involving a buy or sell order.

15. The computer program product of claim 12 wherein buy orders are issued when the total amount invested in the security does not exceed the budget parameter and the customer has available funds and the monitored price is below the trading band value.

16. The computer program product of claim 12 wherein sell orders are issued when the monitored price is above a trading band value.

17. The computer program product of claim 12 wherein the target growth is a first set and the budget is a first budget further comprising instructions to:
establish by a firm that markets the dynamic trading investment product, plural dynamic trading investment products for a security, with each of the dynamic trading investment products having an established target growth and target price.

18. The computer program product of claim 12 further comprising instructions to:
deposit cash generated by the security though dividends in a cash account.

19. A system comprises:
a processor;
memory coupled to the processor with the processor configured to execute a computer program product for administering a dynamic trading investment product that holds at least one security, the computer program product comprising instructions for causing the processor to:
establish a dynamic trading investment product account for an investor, the dynamic trading investment product account holding at least one security;
receive from an investor a budget parameter established by the investor for the security, the budget parameter being a value of an amount of the at least one security;
monitor the price of the at least one security during secondary trading on a trading venue;
determine according to the monitored price and target growths whether to issue orders to buy or sell the security; and when determined to issue orders,
cause an issue of orders to buy or orders to sell the according to the monitored price and target growths; and
add shares to or removing shares from the dynamic trading investment product of the investor according to whether the issued orders are orders to buy or sell the security.

20. The system of claim 19 wherein the computer program product further comprising instructions to:
determine a trading band that is a value of the target price of the at least one security and the target growth amount plus an amount that accounts for trading fees involved in a transaction involving a buy or sell order.

21. The system of claim 19 wherein buy orders are issued when the total amount invested in the security does not exceed the budget parameter and the customer has available funds and the monitored price is below the trading band value.

22. The system of claim 19 wherein sell orders are issued when the monitored price is above a trading band value.

23. The system of claim 19 wherein the target growth is a first set and the budget is a first budget further comprising instructions to:
establish by a firm that markets the dynamic trading investment product, plural dynamic trading investment products for a security, with each of the dynamic trading investment products having an established target growth and target price.

24. The system of claim 19 wherein the computer program product further comprising instructions to:
deposit cash generated by the security though dividends in a cash account.
